(19) United States
(12) Patent Application Publication
(10) Pub. No.: US 2006/0023325 A1
(43) Pub. Date: Feb. 2, 2006

(54) Ray path adjustment structure for optical module

(75) Inventor: Shih-Yuan Kuo, Yonghe City (TW)

Correspondence Address: Welsh & Katz, Ltd.;Eric D. Cohen, 22nd Floor, 120 South Riverside Plaza, Chicago, IL, 60606, US

(73) Assignee: Lite-On Technology Corporation, Taipei (TW)

(21) Appl. No.: 10/900,870

(22) Filed: Jul. 28, 2004

(51) Int. Cl. G02B 6/30

(52) U.S. Cl. 359/872; 359/838

(57) ABSTRACT

A ray path adjustment structure of an optical module includes ray path adjusting components. The ray path adjusting components is mounted in a ray path of the optical module for adjusting the ray path and making an incident light to be the angle which is perpendicular to lens of the optical module.

### FIELD OF THE INVENTION

The invention relates to a ray path adjustment structure for an optical module.

### BACKGROUND OF THE INVENTION

In recent years, under high-tech industrial impetus, all electronic industries are vigorously developed. The modern products, like computers, computer peripherals, electrical appliances, office equipments and so on, have considerable progresses in functions and appearances. Taking scanners for an example, the resolutions have been upgraded to more than 1200 dpi only during several years. If processed by interpolation, the resolution may even reach as high as 9600 dpi. The improvements are really fast. The competition in the present scanner market is extremely intense. All suppliers devote to researches and developments of better performance and lower price products in order to win consumer's favors and increase the market shares. Therefore, how to improve the product potency in the restricted price is the same target for all research and development personnel.

Most scanners in the current market use charge coupled devices (CCD) as light detectors to detect the reflective light reflected from the scanned document. In order to enable the reflective light reliably mapping on the charge coupled device module, the reflective light must vertically approach the charge coupled device module for the best image pickup effect. Therefore, for improving scanning quality, it is necessary to adjust the ray path for truly revealing the scanning image.

In practical applications, the charge coupled device module is mounted on a lens box of an optical module. The incident light reflected from the scanned document passes the lens box and maps on the charge coupled device module. The assembly of the charge coupled device module and the lens box is called an optical module. The optical path adjustment of the optical module is relative to the image quality. At present, the industries use three-axis and five-axis adjustment systems. The three-axis adjustment system first adjusts the charge coupled device module in the vertical, horizontal and vertical swivel directions to locate the charge coupled device module in an appropriate position. Then adjusts the lens of the focal distance. On the other hand, the five-axis adjustment system, via certain components with the charge coupled device module, first fixes the lens box, then adjusts the charge coupled device module in the vertical, horizontal-X, vertical swivel, horizontal swivel and horizontal-Y directions.

FIG. 1 shows an exploded view of a three-axis adjustment optical module. The three-axis adjustment optical module 200 includes a lens box 210 and a charge coupled device module 220. The lens box 210 includes a coupling window 210a to mount the charge coupled device module 220. As shown in the drawing, the coupling window 210a is formed with screw holes 240. When assembling, screws 230 pass the charge coupled device module 220 and firmly fix the module 220 to the coupling window 210a via the screw holes 240.

It is simple to adjust the three-axis adjustment optical module 200 because the charge coupled device module 220 is firmly fixed to the lens box 210. Therefore, the optical path adjustment is just to adjust the charge coupled device module 220 in the vertical, horizontal and vertical swivel directions and to locate the charge coupled device module 220 in an appropriate position. After adjusting the optical path, adjust the lens box 210 of its focal distance to complete the focusing. Please note that the focus adjustment is to move the focal point along the X-axis direction, therefore, the focal point and the charge coupled device module 220 are at relative positions along the X-axis. Though some people regard this as a four-axis adjustment, it should be more rigorous and appropriate to view it a three-axis adjustment optical module because the focusing is made only by the relative X-axis movement of the charge coupled device module 220.

In summary, the advantages of a three-axis adjustment optical module 200 are that it can be adjusted by the least adjustments of components, and the cost for the adjustment fixtures is also the lowest, so that it is widely adopted by most manufacturers. On the other hand, in order to keep the lowest cost, the lens box 210 is usually made of plastics through mold injection. In the process of injection, some slight defects may cause the coupling window 210a not parallel to the Y-Z plane, so that the surface of the charge coupled device module 220 is unable to be parallel with the Y-Z plane after the charge coupled device module 220 being mounted on the coupling window 210a. In that case, the three-axis adjustment is unable to overcome the problem because the charge coupled device module 220 is unable to perform a horizontal swivel adjustment. Because the three-axis adjustment optical module is short of adjustment function of horizontal swivel, the adjustment is unable to achieve the optimal condition, and the scanning quality is degraded.

In order to solve the above problem, a five-axis adjustment optical module is developed, which is capable of adjusting the charge coupled device module in five directions of vertical, horizontal-X, vertical swivel, horizontal swivel and horizontal-Y so as to improve the scanning quality. Please refer to FIG. 2, an exploded view of a five-axis adjustment optical module, a five-axis adjustment optical module 300 includes a lens box 310, a charge coupled device module 320, an element 330, an element 340 and an element 350. The lens box 310 is formed with a coupling window 310a for mounting the element 330. The charge coupled device module 320 is mounted on the element 350. By referring to FIG. 1 and FIG. 2, it is apparent that the differences among them are the elements 330, 340 and 350. The five-axis optical module 300 is achieved of five-direction adjustments by the elements 330, 340 and 350. Though the five-axis adjustment module 300 provides higher accuracy, it requires high cost fixtures, many components and higher component cost, which relatively reduce the product competitive ability.

As described above, conventional optical modules have the following disadvantages:
1) A three-axis adjustment optical module is unable to perform a horizontal swivel adjustment of the charge coupled device module, so that an optimal adjustment cannot be achieved;
2) Though a five-axis adjustment optical module can perform five-direction adjustments, it requires more components, higher cost, and causes a lower competitive ability.

### SUMMARY OF THE INVENTION

The object of the invention is to provide an adjustment structure capable of adjusting the ray path of an optical module and making the incident light to be the angle which is perpendicular to the lens.

A ray path adjustment structure according to the invention mainly includes ray path adjusting components located in ray path of the optical module for adjusting the light and enabling the incident light to be the angle which is perpendicular to the lens.

An embodiment of the invention includes a pivoting mirror and two fixing stands. The pivoting mirror includes a reflector. The two fixing stands are mounted on the lens box of the optical module for supporting both ends of pivoting mirror and enabling swivel the angle of the pivoting mirror to adjust the incident light to be the angle which is perpendicular to the surface of the lens.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is an exploded view of a three-axis adjustment optical module;

FIG. 2 is an exploded view of a five-axis adjustment optical module;

FIG. 3 is an exploded view of a first embodiment of the invention;

FIG. 4 is a constructional view of the first embodiment of the invention which is mounted to a lens box;

FIG. 5 is another constructional view of the first embodiment of the invention which is mounted to a lens box;

FIG. 6 is further another constructional view of the first embodiment of the invention which is mounted to a lens box;

FIG. 7 is again another constructional view of the first embodiment of the invention which is mounted to a lens box;

FIG. 8 is an exploded view of a second embodiment of the invention;

FIG. 9 is a constructional view of the second embodiment of the invention which is mounted to a lens box.

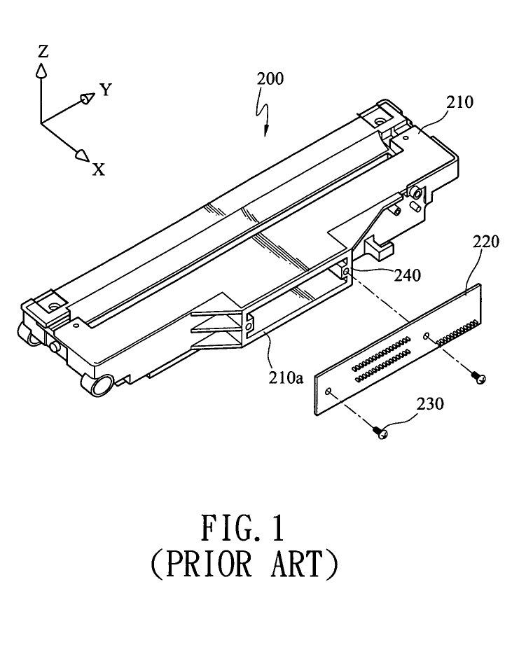

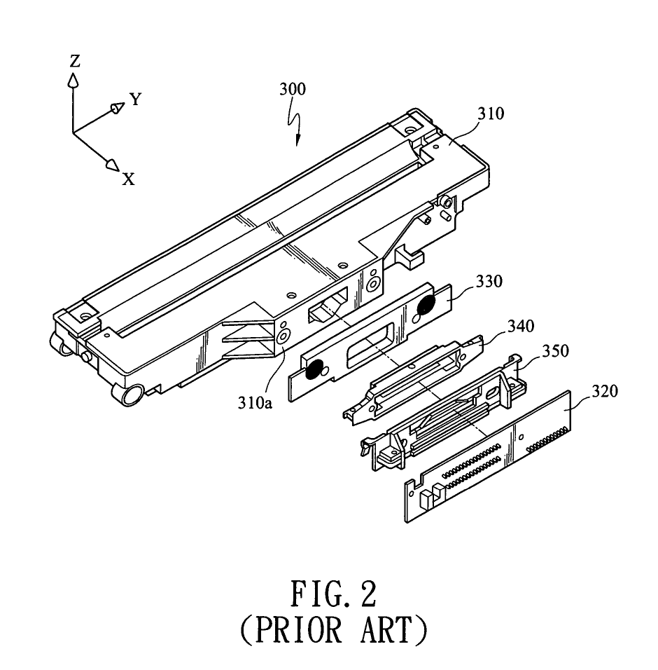

### DETAILED DESCRIPTION OF THE INVENTION

The invention provides an adjustment structure capable of adjusting the ray path of an optical module and making the incident light to be the angle which is perpendicular to the lens.

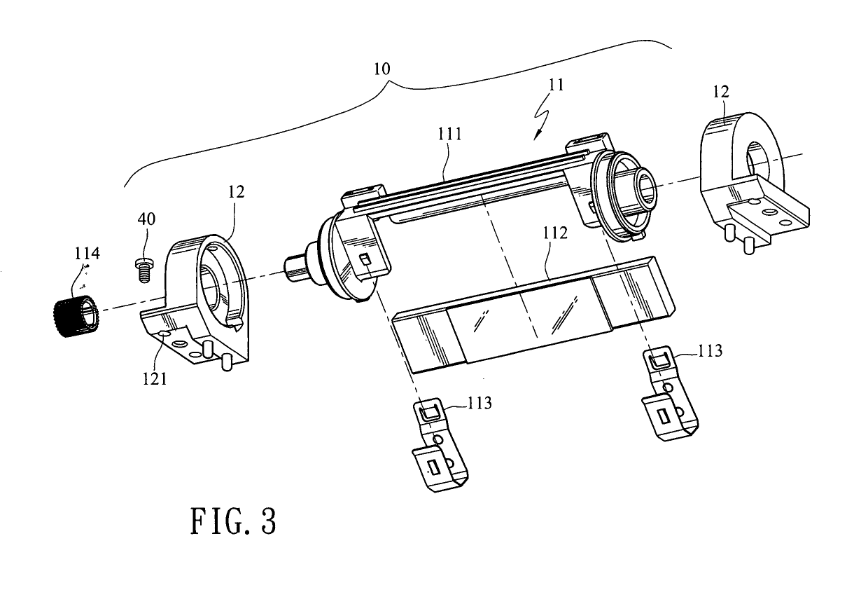

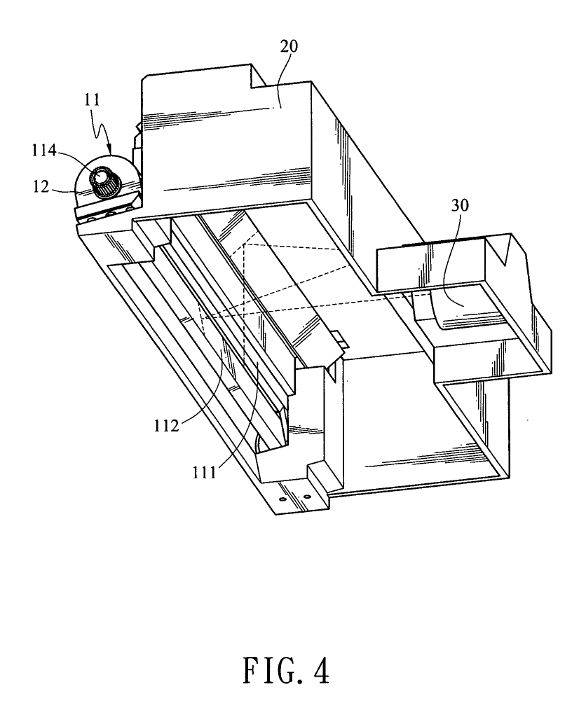

FIG. 3 shows an exploded view of a first embodiment of the invention. FIG. 4 shows a constructional view of the first embodiment of the invention which is mounted to a lens box. The optical module of the invention includes ray path adjusting components 10 located in the ray path of the optical module for adjusting the incident ray to be the angle which is perpendicular to the lens for incident to the lens.

The ray path adjusting components 10 in the first embodiment includes a pivoting mirror 11 and two fixing stands 12. The pivoting mirror 11 includes a pivotal member 111, a reflector 112, two fixing clamps 113 and a knob 114. The reflector 112 is fixed to the pivotal member 111, which are held by the fixing clamps 113 for supporting the reflector 112 on the pivotal member 111. The knob 114 is fixed on an end of the pivotal member 111 and exposed through the fixing stand 12 for user to revolve the pivotal member 111. The two fixing stands 12 are mounted on the lens box 20 of the optical module for supporting the pivotal member 111. By swiveling the angle of the reflector 112, the optical path is adjusted. The fixing stands 12 include screw holes 121 for fixing to the lens box 20.

In assembly of the first embodiment, the reflector 112 is first mounted on the pivotal member 111 where the fixing clamps 113 hold the reflector 112 in place and support both ends of the pivotal member 111 on the fixing stands 12. The knob 114 is then fixed to the pivotal member 111 to finish the assembly. Some screws 40 pass through the screw holes 121 for fixing the assembly to the lens box 20.

In adjustment of the angle of the reflector 112, the knob 114 is swiveled to adjust the angle of the reflector 112. The angular adjustment of the reflector 112 changes the optical path. Finally, the reflector 112 is fixed with that angle.

As shown in FIG. 4, an incident light of the lens 30 is reflected by the reflector 112 and another mirror. The ray path adjusting components 10 adjusts the incident light to be the angle which is perpendicular to the lens 30 for incident to the lens.

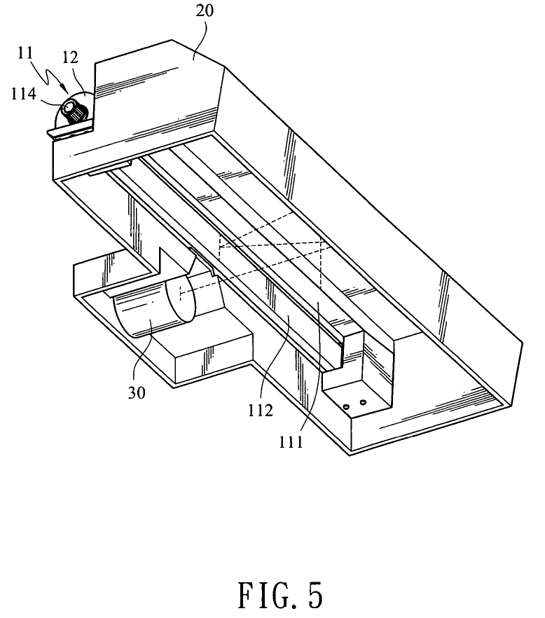

As shown in FIG. 5, a first embodiment of the invention is mounted to a lens box with another arrangement. An incident light of the lens 30 is reflected by a mirror, then the reflector 112 and another mirror. The ray path adjusting components 10 adjusts the incident light to be the angle which is perpendicular to the lens 30 for incident to the lens.

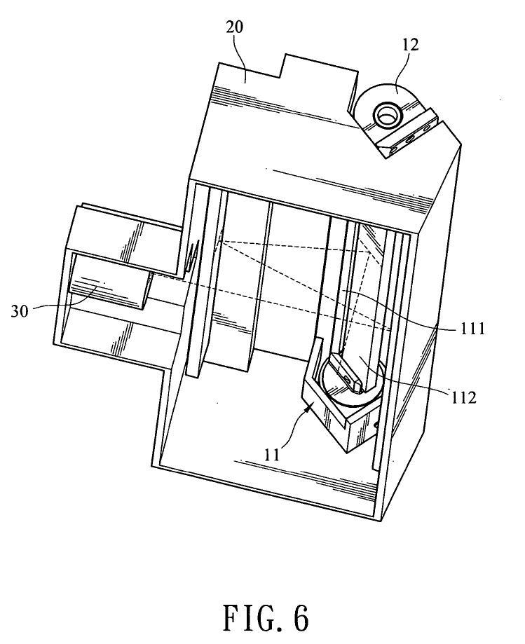

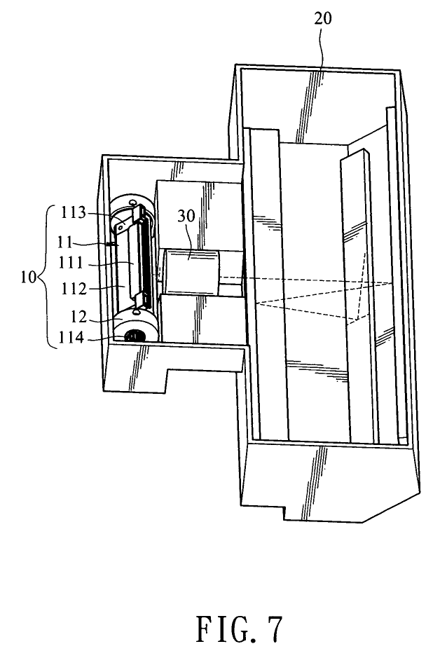

Further, as shown in FIGS. 6 and 7, a first embodiment of the invention is mounted to a lens box with other arrangements. The ray path adjusting components 10 is mounted at any position in the ray path. An incident light of the lens 30 is reflected by the reflector 112 and some other mirrors. The ray path adjusting components 10 adjusts the incident light to be the angle which is perpendicular to the lens 30 for incident to the lens.

The first embodiment of the invention is applicable to aforesaid conventional three-axis, four-axis or five-axis adjustment optical modules of prior arts so as to increase another axis adjustment.

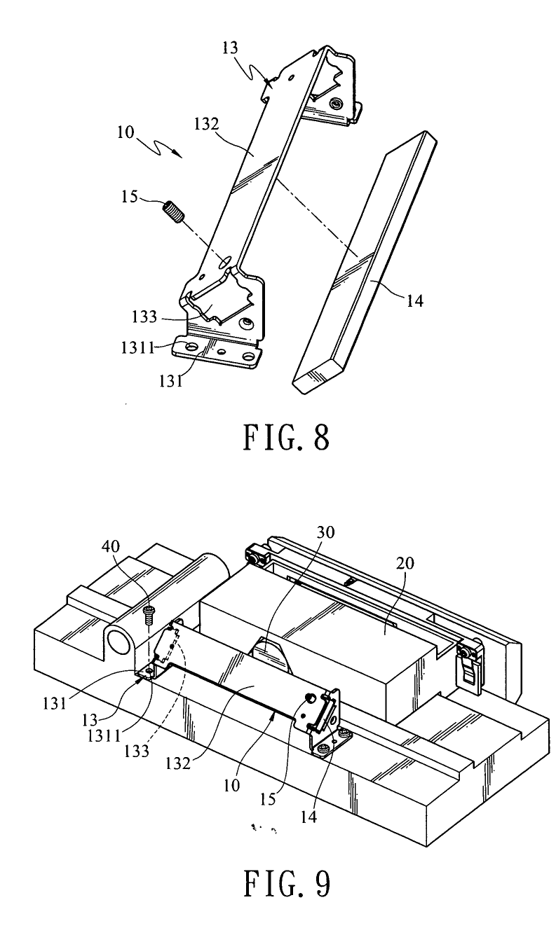

FIG. 8 shows an exploded view of a second embodiment of the invention. FIG. 9 shows a constructional view of the second embodiment of the invention which is mounted to a lens box. The optical module of the invention includes ray path adjusting components 10 located in the ray path of the optical module for adjusting the incident ray to be the angle which is perpendicular to the lens for incident to the lens.

The ray path adjusting components 10 of the second embodiment of the invention include a mirror holder 13, a reflector 14 and a knob 15. The mirror holder 13 includes fixing stands 131, a protective plate 132 and fixing slots 133. The fixing stands 131 are formed on both ends of the protective plate 132 and formed with fixing slots 133. The fixing stands 131 are formed with screw holes 1311 for screws 40 passing through and fixing on a lens box 20 of an optical module. Both ends of the reflector 14 are mounted in the fixing slots 133. The knob 15 adjusts the angle of the reflector 14 and adjusts the optical path.

In assembly of the second embodiment, the reflector 14 is mounted on the fixing slots 133 of the mirror holder 13. The screws 40 pass through the screw holes 1311 for fixing the assembly to the lens box 20.

In adjustment of the reflector 14, the knob 15 is swiveled to adjust the angle of the reflector 14. The angular adjustment of the reflector 14 changes the optical path. Finally, the reflector 14 is fixed with that angle.

An incident light of the lens 30 is reflected by the reflector 112 and another mirror. The ray path adjusting components 10 adjusts the incident light to be the angle which is perpendicular to the lens 30 for incident to the lens.

Similarly, the ray path adjusting components 10 is mounted at any position in the ray path. An incident light of the lens 30 is reflected by the reflector 14 and some other mirrors. The ray path adjusting components 10 adjusts the incident light to be the angle which is perpendicular to the lens 30 for incident to the lens.

The second embodiment of the invention is applicable to aforesaid conventional three-axis, four-axis or five-axis adjustment optical modules of prior arts so as to increase another axis adjustment.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A ray path adjustment structure of an optical module comprises ray path adjusting components mounted in a ray path of said optical module for adjusting said ray path and making an incident light to be the angle which is perpendicular to lens of said optical module for incident to the lens.

2. The ray path adjustment structure of an optical module according to claim 1 wherein said ray path adjusting components comprise:
a pivoting mirror, having a reflector; and
two fixing stands, mounting on a lens box of said optical module for pivotally supporting two ends of said pivoting mirror, in order to adjust angle thereof and adjust said ray path.

3. The ray path adjustment structure of an optical module according to claim 2 wherein said pivoting mirror further comprises a pivotal member and two fixing clamps, said reflector is mounted on said pivotal member, and held and fixed by said fixing clamps.

4. The ray path adjustment structure of an optical module according to claim 2 wherein said pivoting mirror further comprises a knob, formed on an end of said pivotal member, and exposed through said fixing stand for user to revolve said pivotal member.

5. The ray path adjustment structure of an optical module according to claim 2 wherein said fixing stands comprise screw holes for being fixed by screws to said lens box.

6. The ray path adjustment structure of an optical module according to claim 1 wherein said ray path adjusting components comprise:
a mirror holder, mounted on a lens box of said optical module;
a reflector, mounted on said mirror holder; and
a knob, fixed to said mirror holder for adjusting angle of said reflector and adjusting said ray path.

7. The ray path adjustment structure of an optical module according to claim 6 wherein said mirror holder comprises fixing stands, a protective plate and fixing slots, said fixing stands are formed on both ends of said protective plate, said fixing slots are formed on said fixing stands for mounting said reflector.

8. The ray path adjustment structure of an optical module according to claim 7 wherein said fixing stands comprise screw holes for being fixed by screws to said lens box.
